(19) United States
(12) Patent Application Publication
(10) Pub. No.: US 2021/0078810 A1
(43) Pub. Date: Mar. 18, 2021

(54) Handling Head for Raw Tyre Treads

(71) Applicant: DESMASA, S.L., Burgos (ES)

(72) Inventor: Carlos HERNANDO SAIZ, Burgos (ES)

(21) Appl. No.: 17/022,860

(22) Filed: Sep. 16, 2020

(30) Foreign Application Priority Data
Sep. 16, 2019 (EP) 19382799.5

(51) Int. Cl. B65G 47/90

(52) U.S. Cl. CPC B65G 47/90; B65G 2201/0273

(57) ABSTRACT

The present invention relates to a handling head for raw tyres which enables the handling of the raw tyre from a horizontal position to a vertical position to be performed, as well as the readjustment of the diameter and the ejection of the raw tyre to be stored or taken to a vulcanising station once said diameter has been readjusted.

### OBJECT OF THE INVENTION

The present invention relates to a handling head for raw tyres which enables the handling of the raw tyre from a horizontal position to a vertical position to be performed, as well as the readjustment of the diameter and the ejection of the raw tyre to be stored or taken to a vulcanising station once said diameter has been readjusted.

### BACKGROUND OF THE INVENTION

In the tyre manufacturing industry, these are produced from a raw tyre made of rubber which exhibits an extensively plastic behaviour. For the material to become elastic, it needs to be vulcanised in a curing press. Given the weight of the raw tyre and the extensively plastic nature of the material from which it is made, the operations for handling the raw tyre prior to the vulcanising are particularly delicate.

To do so, machines are used which handle the raw tyre from a horizontal position to a vertical position and then introduce it into a robot that grasps it, readjusts the diameter and pushes it in order to store the same or for it to be taken to a vulcanising station once said diameter has been readjusted.

There are other machines intended to handle rigid tyres comprising fastening means which support the rigid tyre by the inner ring thereof, but which are not suitable for performing the handling of raw tyres since these would be deformed.

The applicant does not know of any handling head for raw tyres that solves the aforementioned problems.

### DESCRIPTION OF THE INVENTION

The present invention relates to a handling head for raw tyres which enables the handling of the raw tyre from a horizontal position to a vertical position to be performed, as well as the readjustment of the diameter and the ejection of the raw tyre to be stored or taken to a vulcanising station once said diameter has been readjusted.

The handling head for raw tyres comprises:
fastening means configured to fasten a raw tyre in an essentially horizontal position and in an essentially vertical position.

Optionally, the fastening means configured to fasten a raw tyre in an essentially horizontal position and in an essentially vertical position comprise a main support and at least one secondary support rotatably linked to the main support, wherein the at least one secondary support comprises at least one roller for fastening the raw tyre.

Optionally, the fastening means configured to fasten a raw tyre in an essentially horizontal position and in an essentially vertical position are at least partially collapsible.

Optionally, the handling head for raw tyres further comprises ejection means configured to remove the raw tyre from the handling head.

Optionally, the fastening means configured to fasten a raw tyre in an essentially horizontal position and in an essentially vertical position further comprise at least one support plate configured to act as support for the flank of the raw tyre.

In this manner, the head thus configured enables the combination of the handling tasks of the raw tyre from a horizontal position to a vertical position, as well as the readjustment of the diameter and the ejection of the raw tyre to be stored or taken to a vulcanising station once said diameter has been readjusted.

The invention also relates to a handling machine for raw tyres comprising:
a chassis;
at least one arm of a robot comprising a first connecting end to connect the arm of the robot to the chassis; and
the handling head for raw tyres described above.

Optionally, the at least one arm of a robot comprises a second connecting end to connect to the handling head opposite from the first connecting end.

### BRIEF DESCRIPTION OF THE DRAWINGS

FIG. 1 shows a perspective view of the handling head for raw tyres of the present invention prior to fastening the raw tyre in an essentially horizontal position.

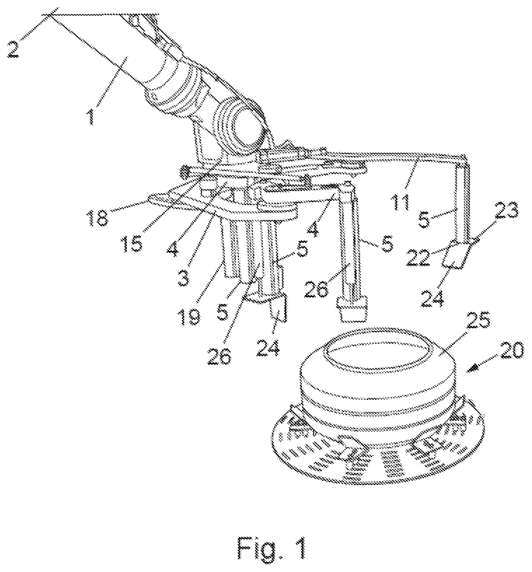

FIG. 2 shows a perspective view of the handling head for raw tyres of the present invention wherein the raw tyre is fastened in an essentially horizontal position.

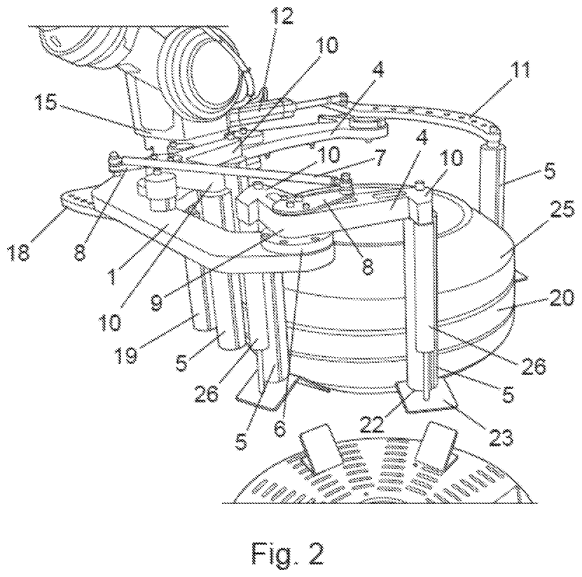

FIG. 3 shows a perspective view of the handling head for raw tyres of the present invention wherein the raw tyre is fastened in an essentially vertical position.

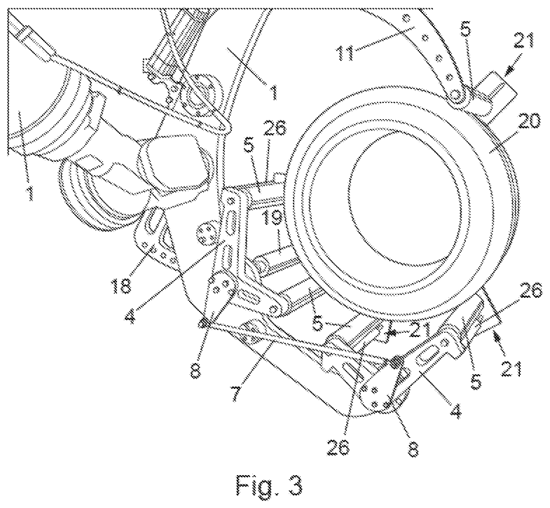

FIG. 4 shows a perspective view of the handling head for raw tyres of the present invention wherein the fastening means configured to fasten a raw tyre in an essentially horizontal position and in an essentially vertical position are at least partially collapsed.

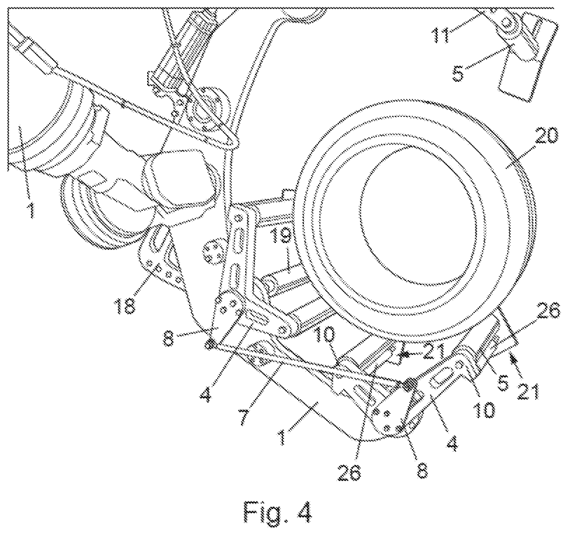

FIG. 5 shows a perspective view of the handling head for raw tyres of the present invention wherein the ejection means configured to remove the raw tyre from the head acting on said tyre are shown.

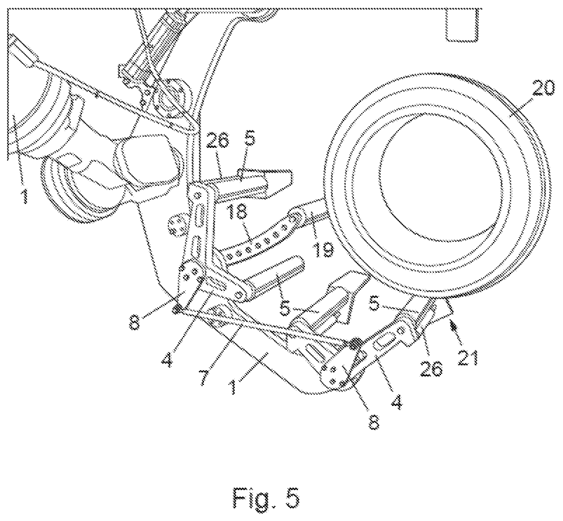

### PREFERRED EMBODIMENT OF THE INVENTION

In a preferred embodiment of the invention, the handling head for raw tyres comprises:
fastening means (3, 4, 5, 6, 7, 8, 9, 10, 11, 12, 21, 22, 23, 24) configured to fasten a raw tyre (20) in an essentially horizontal position and in an essentially vertical position.

The fastening means (3, 4, 5, 6, 7, 8, 9, 10, 11, 12, 21, 22, 23, 24) configured to fasten a raw tyre (20) in an essentially horizontal position and in an essentially vertical position comprise a main support (3) and two secondary supports (4) rotatably linked to the main support (3), wherein the secondary supports (4) comprise rollers (5) for fastening the raw tyre (20).

The secondary supports (4) are rotatably linked to the main support (3), preferably through at least one first actuator (6).

In this exemplary embodiment, the fastening means (3, 4, 5, 6, 7, 8, 9, 10, 11, 12, 21, 22, 23, 24) comprise tertiary supports (8) connected, preferably without the possibility of rotation, to the secondary supports (4) and a connecting rod (7) of the tertiary supports (8), thus configuring an articulated quadrilateral which links the movement of the two secondary supports (4).

The secondary supports (4) comprise a first connecting end (9) to connect to the main support (8) and a second connecting end (10) at which the rollers (5) for fastening the raw tyre (20) are connected.

In this preferred embodiment, the secondary supports (4) are L-shaped, wherein at each of the free ends of the L there is a fastening roller (5) fastened to fasten the raw tyre (20) and wherein each secondary support (4) is connected to the main support (3) at the intersection of the two branches of the L, which coincides with the first connecting end (9) to connect to the main support (8).

The fastening means (3, 4, 5, 6, 7, 8, 9, 10, 11, 12, 21, 22, 23, 24) configured to fasten a raw tyre (20) in an essentially horizontal position and in a essentially vertical position are at least partially collapsible. In this exemplary embodiment, the fastening means (3, 4, 5, 6, 7, 8, 9, 10, 11, 12, 21, 22, 23, 24) comprise a collapsible support (11) which is collapsible, preferably through a second actuator (12), from an open position to a closed position, in an essentially horizontal position, in order to perform the fastening of the raw tyre (20), and from the closed position to the open position, in an essentially vertical position, in order to perform the release of the raw tyre (20) once the necessary work has been performed thereon.

The handling head for raw tyres further comprises ejection means (18, 19) configured to remove the raw tyre (20) from the head, wherein these ejection means (18, 19) comprise a collapsible ejection arm (18) connected to an ejection roller (19), which act when the collapsible support (11) is in an essentially vertical position once the release of the raw tyre (20) has been performed.

The fastening means (3, 4, 5, 6, 7, 8, 9, 10, 11, 12, 21, 22, 23, 24) further comprise a support plate (21) configured to act as support for the flank (25) of the raw tyre (20).

Additionally, the head comprises pneumatic-type actuators (26), linked to the rollers (5), and configured to move the plates (21) from a first position wherein the second section (24) stays parallel to the shaft of the roller (5), to a second position wherein the second section (24) forms a certain angle to support the raw tyre (20) on the plate (21). In this way, the head descends axially in order to collect the raw tyre (20), the plates (21) being in the first position, and once the head is in a suitable position, the actuators (26) are activated, the second section (24) of the platens staying parallel to and supported on the flank (25) of the raw tyre (20).

Preferably, the support plate (21) comprises a first section (23) perpendicular to a shaft of the fastening roller (5) for fastening the raw tyre (20) followed by a second oblique section (24) configured to support the flank (25) of the raw tyre (20).

The at least one support plate (21) is arranged at one end (22) of at least one of the fastening rollers (5) for fastening the raw tyre (20), the end (22) opposite from the second connecting end (10) of the fastening rollers (5) for fastening the secondary supports (4) of the raw tyre (20).

The invention also relates to a handling machine for raw tyres comprising:
a chassis;
at least one arm of a robot (1) comprising a first connecting end (2) to connect the arm of the robot (1) to the chassis;
the handling head for raw tyres described above.

wherein, the at least one arm of a robot (1) comprises a second connecting end (15) to connect to the handling head opposite from the first connecting end (2).

1. A handling head for raw tyres comprising:
fastening means configured to fasten a raw tyre in an essentially horizontal position and in an essentially vertical position.

2. The handling head for raw tyres of claim 1 wherein the fastening means configured to fasten a raw tyre in an essentially horizontal position and in an essentially vertical position comprise a main support and at least one secondary support rotatably linked to the main support, wherein the at least one secondary support comprises at least one fastening roller for fastening the raw tyre.

3. The handling head for raw tyres of claim 2 wherein the fastening means configured to fasten a raw tyre in an essentially horizontal position and in an essentially vertical position comprise a main support and two secondary supports rotatably linked to the main support, wherein the secondary supports comprise fastening rollers for fastening the raw tyre.

4. The handling head for raw tyres of claim 3 wherein the secondary supports are rotatably linked to the main support.

5. The handling head for raw tyres of claim 4 wherein the fastening means comprise tertiary supports connected to the secondary supports and a connecting rod of the tertiary supports, thus configuring an articulated quadrilateral which links the movement of the two secondary supports.

6. The handling head for raw tyres of claim 2, wherein the secondary supports comprise a first connecting end to connect to the main support and a second connecting end at which the fastening rollers for fastening the raw tyre are connected.

7. The handling head for raw tyres of claim 2 wherein the secondary supports are L-shaped, wherein at each of the free ends of the L there is a fastening roller fastened to fasten the raw tyre and wherein each secondary support is connected to the main support at the intersection of the two branches of the L.

8. The handling head for raw tyres of claim 1 wherein the fastening means configured to fasten a raw tyre in an essentially horizontal position and in an essentially vertical position are at least partially collapsible.

9. The handling head for raw tyres of claim 8 wherein the fastening means comprise a collapsible support which is collapsible, preferably through a second actuator, from an open position to a closed position, in the essentially horizontal position, and from the closed position to the open position, in the essentially vertical position.

10. The handling head for raw tyres of claim 1, further comprising ejection means configured to remove the raw tyre from the machine.

11. The handling head for raw tyres of claim 8 wherein the ejection means comprise a collapsible ejection arm connected to an ejection roller.

12. The handling head for raw tyres of claim 1, wherein the fastening means configured to fasten a raw tyre in an essentially horizontal position and in an essentially vertical position further comprise at least one support plate configured to act as support for the flank of the raw tyre.

13. The handling head for raw tyres of claim 2 wherein the at least one support plate comprises a first section perpendicular to a shaft of the fastening roller for fastening the raw tyre followed by a second oblique section configured to support the flank of the raw tyre.

14. The handling head for raw tyres of claim 13, further comprising actuators configured to move the plates from a first position wherein the second section is parallel to the shaft of the roller, to a second position wherein the second section forms a certain angle to support the raw tyre on the plate.

15. A handling machine for raw tyres comprising:
a chassis;
at least one arm of a robot comprising a first connecting end to connect the arm of the robot to the chassis; and
a handling head for raw tyres comprising fastening means configured to fasten a raw tyre in an essentially horizontal position and in an essentially vertical position.

16. The handling machine for raw tyres of claim 15, wherein the at least one arm of a robot comprises a second connecting end to connect to the handling head opposite from the first connecting end.

17. The handling head for raw tyres of claim 4 wherein the secondary supports are rotatably linked to the main support through at least one first actuator.

18. The handling head for raw tyres of claim 4 wherein the fastening means comprise tertiary supports connected, without the possibility of rotation, to the secondary supports and a connecting rod of the tertiary supports, thus configuring an articulated quadrilateral which links the movement of the two secondary supports.

19. The handling head for raw tyres of claim 3, wherein the secondary supports comprise a first connecting end to connect to the main support and a second connecting end at which the fastening rollers for fastening the raw tyre are connected.

20. The handling head for raw tyres of claim 19 wherein the secondary supports are L-shaped, wherein at each of the free ends of the L there is a fastening roller fastened to fasten the raw tyre and wherein each secondary support is connected to the main support at the intersection of the two branches of the L.
